(19) United States
(12) Patent Application Publication
(10) Pub. No.: US 2026/0050783 A1
(43) Pub. Date: Feb. 19, 2026

(54) METHODS AND SYSTEMS FOR TRAINING INTERPRETABLE LATENT FEATURE MACHINE LEARNING MODELS BASED ON CLASS COVERAGE

(71) Applicant: FAIR ISAAC CORPORATION, Minneapolis, MN (US)

(72) Inventors: Scott Michael Zoldi, San Diego, CA (US); Shafi Ur Rahman, San Diego, CA (US)

(21) Appl. No.: 18/805,264

(22) Filed: Aug. 14, 2024

(51) Int. Cl. G06N 3/08

(52) U.S. Cl. CPC G06N 3/08

(57) ABSTRACT

A method for generating a classifier, wherein the method comprises generating a set of candidate latent features from a training dataset, evaluating, by the at least one processor, each of the candidate latent features based on a coverage efficiency metric, wherein the coverage efficiency metric balances detection of minority class instances against a minimization of false positives among majority class instances; selecting, by the at least one processor, a first latent feature from the set of candidate latent features based on a ranking of the coverage efficiency metric associated with each of the candidate latent features; partitioning the training dataset by marking the training records identified by the first latent feature as covered records and removing the covered records from the training dataset to form an uncovered dataset; identifying slack features from remaining candidate latent features, training a neural network model using the selected latent features and the slack features.

### TECHNICAL FIELD

The subject matter described herein relates to systems and methods for using Machine Learning (ML) techniques to train robust and interpretable classifiers by aid of class coverage and coverage efficiency, for generating effective and transparent neural network models.

### BACKGROUND

In recent years, Machine Learning (ML) models have gained widespread adoption across various industries for predictive purposes. One of the key challenges with these models is that if sufficient care is not taken while building them, they can easily become over-specified, resulting in more degrees of freedom than necessary. This overspecification reduces predictive power, leads to loss of robustness over time, and encourages the learning of spurious relationships. To achieve a robust model, it is critical to manage the degrees of freedom and ensure transparency by limiting the number of latent features required during training. Unfortunately, this aspect is often ignored by data scientists, leading to rampant over-specified models that exhibit largely non-robust and unpredictable prediction behaviors.

Neural network models, in particular, are among the most powerful ML models available today. Their structure includes one or more hidden layers, each with multiple hidden nodes, or latent features. These latent features express learned non-linear relationships based on inputs and prior layers to create relationships that are more predictive than simply utilizing inputs. However, in practice, considerations such as limiting the number of layers, the number of latent features, and the complexity of these features that are important for bounding the degrees of freedom are often overlooked due to a lack of methods to do so, resulting in fully connected dense neural networks that suffer from noise and instability.

Furthermore, regulatory and governance requirements for AI and ML models are driving the need for interpretable neural networks that can concretely indicate the learned relationships and report back to customers impacted by those relationships. Organizations that do not employ interpretable neural networks lack the ability to articulate, monitor and audit the learned relationships and the importance of these latent features, which can significantly impact the behavior of the deployed models in production. Another significant challenge in machine learning is dealing with class imbalance. In many real-world scenarios, such as fraud detection, the minority class (e.g., fraudulent transactions) is vastly outnumbered by the majority class (e.g., non-fraudulent transactions). Standard training approaches often result in models that perform sub-optimally on the minority class due to the overwhelming influence of the majority class. This imbalance makes it difficult to accurately identify critical instances within the minority class. Despite advancements in techniques such as stratified sampling, regularization, feature selection, and specialized algorithms for handling class imbalance, creating robust, interpretable, and highly predictive models remains a significant challenge. There is a need for innovative approaches that enhance model robustness and interpretability while effectively managing class imbalance, ensuring that critical instances within the minority class are accurately identified without compromising the overall performance of the classifier.

### SUMMARY

Methods, systems, and computer program products are provided for generating a classifier. In one aspect, a computer-implemented method includes generating, by at least one processor, a set of candidate latent features from a training dataset, wherein the training dataset comprises a plurality of training records, and wherein each of the candidate latent features is a function of either a single input variable or a pair of input variables; evaluating, by the at least one processor, each of the candidate latent features based on a coverage efficiency metric, wherein the coverage efficiency metric balances detection of minority class instances against a minimization of false positives among majority class instances; selecting, by the at least one processor, a first latent feature from the set of candidate latent features based on a ranking of the coverage efficiency metric associated with each of the candidate latent features; partitioning the training dataset by marking the training records identified by the first latent feature as covered records and removing the covered records from the training dataset to form an uncovered dataset; iteratively repeating the steps of generating candidate latent features, evaluating coverage efficiency, selecting latent features, and partitioning remaining training dataset in multiple iterations until a predefined stopping criterion is met, wherein the predefined stopping criterion comprises a threshold for false positive rate and a condition for improvement in a detection rate of minority class instances; and training a neural network classifier using the selected latent features.

In some variations, the method further includes identifying a set of slack latent features from remaining candidate latent features to capture minority class instances not detected by the selected latent features, wherein the slack latent features are selected based on an ability to improve detection rate in the uncovered dataset; and training the neural network classifier using both the selected latent features and the slack latent features, wherein a contribution of slack latent features is constrained.

In some variations, training the neural network classifier further comprises retrieving a first set of weights associated with the selected latent features indicating relationships between an input layer and the selected latent features; retrieving a second set of weights associated with the slack latent features indicating relationships between the input layer and the slack latent features; and training the neural network classifier by determining weights from the selected latent features and the slack latent features, wherein the first set of weights are not adjusted during the training of the neural network classifier.

In some variations, the predefined stopping criterion further comprises a determination that an addition of newly-selected latent features does not result in an improvement in classifier performance, measured by an increase in the detection rate of minority class instances while maintaining the false positive rate below the threshold.

In some variations, evaluating each of the candidate latent features based on a coverage efficiency metric further comprises generating an activation dataset, wherein the activation dataset includes binary indicators for each of the training records and each of the candidate latent features, indicating whether a latent feature fires for a training record based on an activation threshold corresponding to the latent feature.

In some variations, the activation threshold is adjusted based in part on a specific iteration of the multiple iterations.

In some variations, the method further comprises combining multiple selected latent features into composite features, wherein the composite features are created based in part on synergistic interactions between the selected latent features.

In another aspect, a computer program product is provided. The computer program product includes a non-transient machine-readable medium storing instructions that, when executed by at least one programmable processor, cause the at least one programmable processor to perform operations comprising generating, by at least one processor, a set of candidate latent features from a training dataset, wherein the training dataset comprises a plurality of training records, and wherein each of the candidate latent features is a function of either a single input variable or a pair of input variables; evaluating, by the at least one processor, each of the candidate latent features based on a coverage efficiency metric, wherein the coverage efficiency metric balances detection of minority class instances against a minimization of false positives among majority class instances; selecting, by the at least one processor, a first latent feature from the set of candidate latent features based on a ranking of the coverage efficiency metric associated with each of the candidate latent features; partitioning the training dataset by marking the training records identified by the first latent feature as covered records and removing the covered records from the training dataset to form an uncovered dataset; iteratively repeating the steps of generating candidate latent features, evaluating coverage efficiency, selecting latent features, and partitioning remaining training dataset in multiple iterations until a predefined stopping criterion is met, wherein the predefined stopping criterion comprises a threshold for false positive rate and a condition for improvement in a detection rate of minority class instances; and training a neural network classifier using the selected latent features.

In some variations, the operations further include identifying a set of slack latent features from remaining candidate latent features to capture minority class instances not detected by the selected latent features, wherein the slack latent features are selected based on an ability to improve detection rate in the uncovered dataset; and training the neural network classifier using both the selected latent features and the slack latent features, wherein a contribution of slack latent features is constrained.

In some variations, training the neural network classifier further includes retrieving a first set of weights associated with the selected latent features indicating relationships between an input layer and the selected latent features; retrieving a second set of weights associated with the slack latent features indicating relationships between the input layer and the slack latent features; and training the neural network classifier by determining weights from the selected latent features and the slack latent features, wherein the first set of weights are not adjusted during the training of the neural network classifier.

In some variations, the predefined stopping criterion further includes a determination that an addition of newly-selected latent features does not result in an improvement in classifier performance, measured by an increase in the detection rate of minority class instances while maintaining the false positive rate below the threshold.

In some variations, evaluating each of the candidate latent features based on a coverage efficiency metric further includes generating an activation dataset, wherein the activation dataset includes binary indicators for each of the training records and each of the candidate latent features, indicating whether a latent feature fires for a training record based on an activation threshold corresponding to the latent feature.

In some variations, the activation threshold is adjusted based in part on a specific iteration of the multiple iterations.

In some variations, the operations further include combining multiple selected latent features into composite features, wherein the composite features are created based in part on synergistic interactions between the selected latent features.

In another aspect, a system is provided. The system includes a programmable processor and a non-transient machine-readable medium storing instructions that, when executed by the processor, cause the at least one programmable processor to perform operations including generating, by at least one processor, a set of candidate latent features from a training dataset, wherein the training dataset includes a plurality of training records, and wherein each of the candidate latent features is a function of either a single input variable or a pair of input variables; evaluating, by the at least one processor, each of the candidate latent features based on a coverage efficiency metric, wherein the coverage efficiency metric balances detection of minority class instances against a minimization of false positives among majority class instances; selecting, by the at least one processor, a first latent feature from the set of candidate latent features based on a ranking of the coverage efficiency metric associated with each of the candidate latent features; partitioning the training dataset by marking the training records identified by the first latent feature as covered records and removing the covered records from the training dataset to form an uncovered dataset; iteratively repeating the steps of generating candidate latent features, evaluating coverage efficiency, selecting latent features, and partitioning remaining training dataset in multiple iterations until a predefined stopping criterion is met, wherein the predefined stopping criterion includes a threshold for false positive rate and a condition for improvement in a detection rate of minority class instances; and training a neural network classifier using the selected latent features.

In some variations, the operations further include identifying a set of slack latent features from remaining candidate latent features to capture minority class instances not detected by the selected latent features, wherein the slack latent features are selected based on an ability to improve detection rate in the uncovered dataset; and training the neural network classifier using both the selected latent features and the slack latent features, wherein a contribution of slack latent features is constrained.

In some variations, training the neural network classifier further includes retrieving a first set of weights associated with the selected latent features indicating relationships between an input layer and the selected latent features; retrieving a second set of weights associated with the slack latent features indicating relationships between the input layer and the slack latent features; and training the neural network classifier by determining weights from the selected latent features and the slack latent features, wherein the first set of weights are not adjusted during the training of the neural network classifier.

In some variations, the predefined stopping criterion further includes a determination that an addition of newly-selected latent features does not result in an improvement in classifier performance, measured by an increase in the detection rate of minority class instances while maintaining the false positive rate below the threshold.

In some variations, evaluating each of the candidate latent features based on a coverage efficiency metric further includes generating an activation dataset, wherein the activation dataset includes binary indicators for each of the training records and each of the candidate latent features, indicating whether a latent feature fires for a training record based on an activation threshold corresponding to the latent feature.

In some variations, the activation threshold is adjusted based in part on a specific iteration of the multiple iterations.

In some variations, the operations further include combining multiple selected latent features into composite features, wherein the composite features are created based in part on synergistic interactions between the selected latent features.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a is a schematic diagram illustrating the structure of a fully connected dense neural network model with a single hidden layer, in accordance with one or more embodiments of the current subject matter.

FIG. 1b is a schematic diagram illustrating an example of a class coverage-based interpretable latent feature neural network model, in accordance with one or more embodiments of the current subject matter.

FIG. 1c is a diagram illustrating an example of an activation function in a form of a logistic function, in accordance with one or more embodiments of the current subject matter.

FIG. 1d(i) is a diagram illustrating a model where a non-linear transform of a variable vᵢ with weight wᵢ and bias term wₒ has been determined based on the output variable, O, in accordance with one or more embodiments of the current subject matter.

FIG. 1d(ii) is a diagram illustrating a model where a non-linear transform of variable pair vᵢ and vⱼ with weights wᵢ and wⱼ and bias term wₒ have been determined based on the output variable, O, in accordance with one or more embodiments of the current subject matter.

FIG. 2a is a diagram illustrating the values of generated interpretable latent features for a single record, compared against a fixed activation threshold, in accordance with one or more embodiments of the current subject matter.

FIG. 2b is a diagram illustrating the first six records of the dataset D¹, with binary indicators showing whether each of the corresponding latent features is above or below the activation threshold, in accordance with one or more embodiments of the current subject matter.

FIG. 2c is a diagram illustrating the transformed dataset D¹_{LF}, comprising binary indicators

$${I}_{k}^{1}$$

for each record. In this schematic, data is represented in a comma-separated format, where the first column represents a record ID and the rest of the columns represent the firing (or lack of firing) of each latent feature,

$$L {F}_{k}^{1} ,$$

in accordance with one or more embodiments of the current subject matter.

FIG. 2d is a diagram illustrating the dataset with class labels for each of the records. A value of 1 indicates the minority class, and a value of 0 indicates the majority class, in accordance with one or more embodiments of the current subject matter.

FIG. 2e is a diagram illustrating two subsets of the data. The subset on top represents D¹_{LF_minority} and includes records with IDs #1, #4, #6, etc. The subset on the bottom represents D¹_{LF_majority} and includes records with IDs #2, #3, #5, etc. For ease of representation, input variables are not shown in the schematic diagrams, but they are present in the datasets, in accordance with one or more embodiments of the current subject matter.

FIG. 3a is a diagram illustrating a subset of the records identified based on the firing of the highest coverage-based latent feature, LF¹, in accordance with one or more embodiments of the current subject matter.

FIG. 3b is a diagram illustrating the removal of the covered records from further consideration, with the uncovered population represented by D²_{minority} and D²_{majority}, in accordance with one or more embodiments of the current subject matter.

FIG. 4 depicts a block diagram illustrating a computing system consistent with implementations of the current subject matter.

FIG. 5 is a representation of a highly interpretable latent feature neural network architecture based on class coverage latent features, in accordance with one or more embodiments of the current subject matter.

FIG. 6 is a diagram illustrating a flow chat of a process for generating a classifier, in accordance with one or more embodiments of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, neural network models face challenges in achieving interpretability and effectively handling class imbalance. These challenges often result in models that are difficult to understand and perform sub optimally on minority class instances. Addressing these issues is crucial for developing robust and reliable machine learning models.

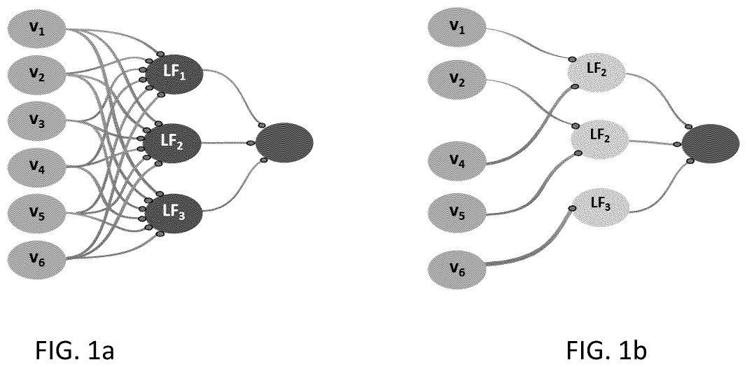

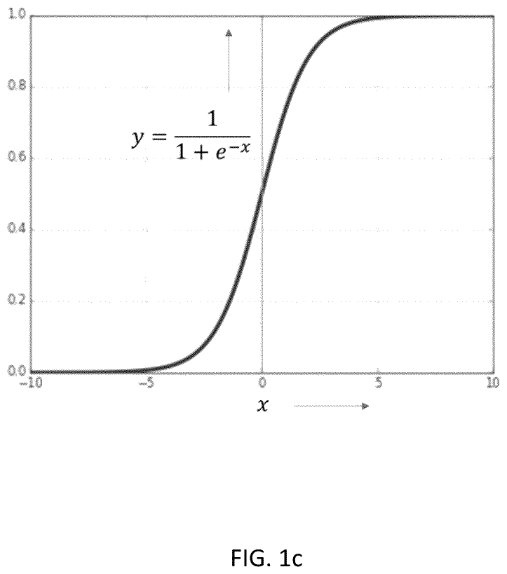

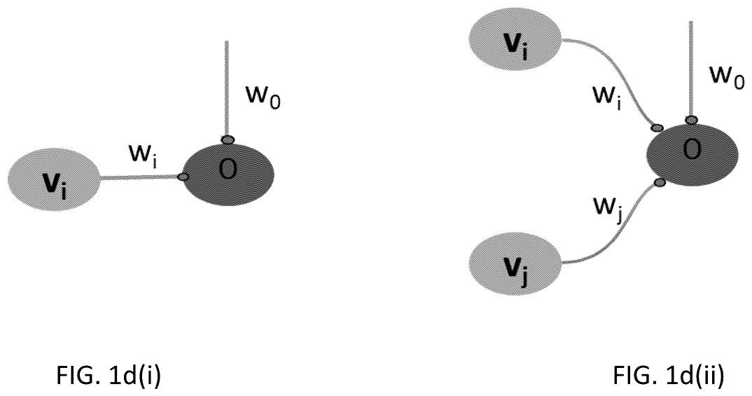

FIG. 1a is a diagram illustrating the structure of a fully connected dense neural network model with a single hidden layer comprising six input variables and three hidden nodes in the hidden layer. In some embodiments, each hidden node represents a latent feature formed by non-linear transformations of the input variables. As shown in FIG. 1a, in the case of a fully connected neural network, the latent features in the first hidden layer are represented by the following canonical form:

$$L {F}_{k} = ϕ ( {w}_{0 k} + {\sum }_{i = 1}^{\vert vars \vert} {w}_{i k} {v}_{i} ) \qquad ( 1. a )$$

Where, LFₖ is the k^{th} latent feature, |vars| is the number of input variables, vᵢ is the i^{th} input variable, and wᵢₖ represents the weight of the connection between input variable vᵢ and latent feature LFₖ that is learnt by a learning algorithm at the time of model training. W₀ₖ is the bias term. ϕ is a non-linear transformation, called an activation function, which usually mimics a step function such as logistic or tanh function. As shown in FIGS. 1a and 1n Equation 1.a, latent features (LF₁, . . . , LF_{N}) represent typically multitudes of complex relationships learned by the network during training (for example, non-linear transformations, and/or interactions of multiple input features). As shown in FIG. 1a, the complexity of the latent features makes even a simple neural network with a single hidden layer and dense connections (i.e., fully connected) very hard to understand and explain.

FIG. 1b is a diagram illustrating an example of a class coverage-based interpretable latent feature neural network model. As shown in FIG. 1b, each latent feature is a function of either a single variable or two input variables, and no two latent features are a function of the same set of input variables. These latent features are selected based on class coverage as described herein elsewhere. This selective approach simplifies the network and improves interpretability, as each latent feature is explicitly defined and limited in scope. By reducing the number of connections and focusing on the most impactful relationships, this approach may enhance robustness and transparency while maintaining high predictive performance. In some embodiments, in a class coverage based interpretable latent feature neural network, the majority of the weights is forced to be 0, and only up to two weights per latent feature to be non-zero. Thus, each latent feature should have no more than two incoming connections, which may be called interpretable latent features, and the Equation 1.a translates to the following form:

$${LF}_{k} = ϕ ( w + {w}_{ik} {v}_{i} ) \qquad ( 1. b )$$

$$Or$$

$${LF}_{k} = ϕ ( {w}_{0 k} + {w}_{ik} {v}_{i} + {w}_{j k} {v}_{j} ) \qquad ( 1. c )$$

Where, LFₖ is the k^{th} interpretable latent feature and is a function of either a single variable vᵢ, or two variables vᵢ and vⱼ respectively. The term latent feature mentioned from here on would mean to imply interpretable latent feature unless otherwise mentioned.

Equations (1.a), (1.b) and (1.c) manifest themselves in terms of an approximation of a step function, which goes quickly from a low value to a high value around an inflection point. This transition as a function of the weighted sum of all the incoming connections is governed by the activation function, ϕ(x). More commonly used activation functions include logistic and tanh functions, but other variations are also used. FIG. 1c is a diagram illustrating an example of an activation function in a form of a logistic function whose output, y, transitions quickly from 0 to 1 at the inflection point, x=0, where the value of y is 0.5. Similarly, for tanh the value is bound between −1 and +1 with the inflection point, x=0, where the activation value is 0. As described herein elsewhere, an exhaustive set of latent features is generated that represents non-linear transformation of single input variable and interaction terms based on two input variables. This list of latent features may be used as candidates for training the interpretable latent feature machine learning model based on class coverage.

### Class Imbalance

Among a variety of use cases, neural network models are often used to perform classification tasks such as predicting credit risk default, likelihood of attrition, flagging credit card fraud, anomaly detection, or identifying a malignant tumor. Most useful classification problems typically have inherent class imbalance. Class imbalance occurs when the instances of two classes in a classification problem are disproportionately unequal. For example, in the case of credit risk default, the number of accounts that default in a single month could be as low as 1% of the active accounts. In this example, accounts with payment defaults are called the minority class, whereas the rest of the accounts are referred to as the majority class due to their preponderance. A classification problem with two classes is also referred to as a binary classification problem. In these situations, minority class instances are labeled as high value, often a value of 1, and majority class instances are labeled as low value of activation, often a value of 0.

### Outline of the Analytic Methodology

When the algorithm begins, the entire dataset is available, and no interpretable latent feature has been selected. The analytic methodology focuses on training and selecting a ranked subset of interpretable latent features from a set of generated one-variable or two-variable interpretable latent features by maximizing the detection of minority class instances while minimizing the misclassification of majority class instances. The method is an iterative process where a set of interpretable latent features is trained on a dataset. Once the best-ranked interpretable latent feature has been selected, the data detected by this selected latent feature, called covered data, is removed from consideration, and the process is repeated on the remaining dataset, called uncovered data. The set of interpretable latent features is relearned on the uncovered data, and from these, the best-ranked interpretable latent feature is selected in a coverage-ranked fashion. These selected latent features are called class coverage latent features. The process is terminated when a termination condition has been reached, often set by an operational aspect such as the proportion of false positives allowed for a latent feature as a stopping criterion. A small number of slack latent features are then identified from the set of interpretable latent features that were learned on the last uncovered data to capture cases not detected by the class coverage latent features. These slack latent features are selected based on their ability to distinguish between minority and majority class instances in the uncovered data. Finally, the class coverage-based interpretable latent feature machine learning model is learned by transferring the coverage latent features and slack latent features using a guided AI approach, where slack latent feature contribution is constrained, and the weights associated with these identified latent features are learned.

The analytic methodology begins by generating a set of interpretable latent features based on single input variables or pairs of two input variables in a provided training dataset. Each interpretable latent feature is then analyzed for both the detection of the minority class and the misclassification of the majority class when they fire. A latent feature fires when its activation value crosses a specified threshold. To determine whether the k^{th} latent feature,

$${LF}_{k}^{p} ,$$

trained during the p^{th} iteration of the algorithm, is firing or not, a conditional check is applied as shown in Equation (2), where

$${LF}_{k}^{p , r}$$

is the value of

$${LF}_{k}^{p}$$

for the r^{th} record trained on the uncovered dataset.

$${I}_{k}^{p , r} = ( 1 if {LF}_{k}^{p , r} > θ , else 0 ) \qquad ( 2 )$$

where, θ is activation threshold for firing.

The resultant binary indicator is called

$${I}_{k}^{p} .$$

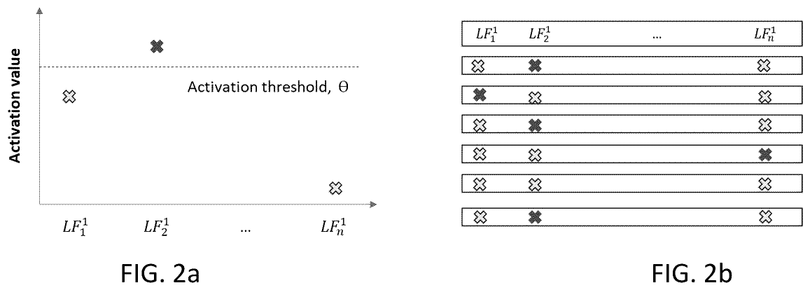

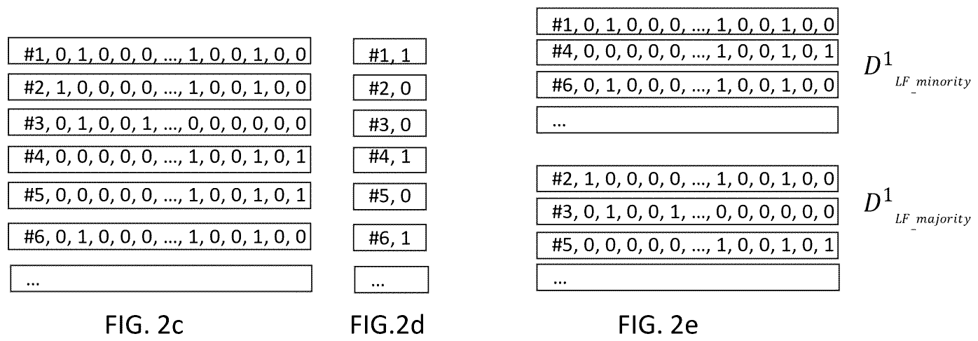

This scheme is illustrated in the schematic in FIGS. 2a-e.

When a latent feature fires for a minority class instance, it is a true positive, and the instance is said to have been detected. If it fires for a majority class, it is a false positive and represents a misclassification of the majority class. The best latent feature is the one that maximizes true positives while minimizing false positives, leading to the best value of Coverage Efficiency. Coverage Efficiency is explained in the section “selecting interpretable latent feature based on class coverage” and is expressed as Equations (5).

The selection criteria for latent features are expressed as a metric that maximizes detection in the minority class while minimizing the false positive ratio. All the records in the training dataset for which the latent feature with the best Coverage Efficiency fires, are tagged as covered data and removed from further consideration. The remainder of the records in the training dataset are uncovered data.

The method iteratively selects a compact set of interpretable latent features that optimally identify the maximum number of minority class instances while firing on as few majority class instances as possible. The subset of examples based on the firing of the best latent feature is labeled and removed as covered data. On the remainder of the uncovered data, a new set of interpretable latent features is learned. The best latent feature from this set of interpretable latent features is then selected based on the same criterion. Care is taken to ensure that the newly learned interpretable latent features on uncovered data are not based on the same variable or variable pair that already defines the set of selected class coverage latent features, LF_{selected}.

Once this subset process of the latent features completes with no further coverage latent features meeting the coverage threshold driven by the false positive metric, the class coverage latent features are fixed, and a small subset of slack latent features is identified to explain the remainder of the minority class instances. This is done by identifying a subset of the latent features from the set of interpretable latent features that were learned on the last uncovered data. Care is taken to ensure that the slack latent features are not based on the same variable or pair of variables that already define the selected class coverage latent features. These slack latent features are selected to be few in number, as specified by a model developer or based on defining the highest next coverages on the uncovered dataset. In other instances, the uncovered data is subject to building an interpretable LF network where the most predictive latent features are selected to a prescribed number.

Together, the class coverage latent features and slack latent features are used to define an interpretable machine learning model with an interpretable latent feature architecture based on class coverage. This architecture is used to train the final model with constraints applied to limit the contribution of slack latent features and maximize the contribution of the class coverage latent features.

### Preparing the Dataset

Class coverage is detected on a given training dataset, D_{T}. A separate holdout dataset, D_{H} is kept aside for measuring performance. An additional out-of-time dataset, D_{OOT} might be used to further quantify the robustness of the model.

### Generating Latent Features

To produce a set of interpretable latent features and subsequently select a class coverage-based interpretable latent feature architecture, an exhaustive set of latent features is generated. These latent features represent non-linear transformations of single input variables and interaction terms based on two input variables. This is achieved by conducting an exhaustive search on a given uncovered dataset, D^{P} where P represents the iteration of the algorithm.

FIG. 1d(i) is a diagram illustrating a model where a non-linear transform of a variable vᵢ with weight wᵢ has been determined based on the output variable, O, in accordance with one or more embodiments of the current subject matter.

FIG. 1d(ii) is a diagram illustrating a model where a variable pair vᵢ and vⱼ with weights wᵢ and wⱼ have been determined based on the output variable, O. The fitting of weights, w, form the expressed interpretable latent feature. In some embodiments, the relationship learned in this manner can be expressed as Equations (3.a) and (3.b) respectively, in accordance with one or more embodiments of the current subject matter.

Small models are trained with a single input variable or two variables as input pairs, with the class label as the binary target variable, O, using the uncovered dataset, D^{P}. FIG. 1d(i) shows such a model where a variable vᵢ has been used to learn the weight of its connection with the binary outcome class treated as target variable, O. The learnt model is represented by equation (3.a). FIG. 1d(ii) shows such a model where a variable pair, vᵢ and vⱼ has been used to learn the weights of their connection with the binary outcome class treated as target variable, O. The learnt model is represented by equation (3.b). Thus, each model learns a different aspect of the binary target variable. Notice the similarity between equations (1.b) and (3.a). Further, notice the similarity between equations (1.c) and (3.b).

$$0 = ϕ ( {w}_{0 k}^{p} + {w}_{i k}^{p} {v}_{i} ) \qquad ( 3. a )$$

$$and ,$$

$$0 = ϕ ( {w}_{0 k}^{p} + {w}_{i k}^{p} {v}_{i} + {w}_{j k}^{p} {v}_{j} ) \qquad ( 3. b )$$

For a given input variable vᵢ and the model fitting above, one and only one candidate latent feature is generated. Similarly, for a given input pair vᵢ and vⱼ, and the model fitting above, one and only one candidate latent feature is generated.

The latent feature thus generated is positively correlated with the outcome variable by virtue of being trained on the outcome variable, O, as the target. This means that the higher activation values of the latent feature tend to correspond to minority class and lower values of the latent feature tend to correspond to majority class. This property has strong benefits that are leveraged in this method and mentioned in the subsequent sections as needed. The resultant interpretable latent feature,

$${LF}_{k}^{p} ,$$

is given by either equation (1.b) or (1.c) discussed earlier, with the weights

$${w}_{0 k}^{p} , {w}_{i k}^{p}$$

and in case of variable pair,

$${w}_{j k}^{p}$$

learnt during model training as per equation (3.a) or (3.b) respectively.

This process is easily automated in a Spark job or other parallelization step, speeding up the creation of the exhaustive set of candidate interpretable latent features. At the end of this step, a complete set of candidate latent features for all 1-variable non-linear transformations and 2-variable interactions is obtained to measure coverage statistics for the given uncovered dataset, D.

### Generating Latent Feature Activation Datasets for Majority and Minority Classes

The algorithm is iterative in nature, determining coverage using the uncovered data in a given iteration. At the start of the algorithm, the entire dataset is considered uncovered data. Thus, beginning with the first iteration, the uncovered data, D¹, is set to be the provided training dataset, D_{T}.

The uncovered dataset D¹ is used to generate the interpretable latent features. As described in the previous section, in the first iteration, represented by the value of p=1, the interpretable latent features are trained using the equations (3.a) and (3.b). Let the k^{th} resultant latent feature be annotated as

$${LF}_{k}^{1} .$$

Once the latent features are learnt, the values of all the learnt interpretable latent features are determined on the uncovered dataset, D¹. For each record r in D¹, the method may compute

$${LF}_{k}^{1 , r} ,$$

which is the latent feature activation value of

$${LF}_{k}^{1 , r}$$

for record r, using the equation (4.a) and (4.b) expressed for a given record, r. This is equivalent to the equation (1.b).

$${LF}_{k}^{1 , r} = ϕ ( {w}_{0 k}^{1} + {w}_{i k}^{1} {v}_{i}^{r} ) \qquad ( 4. a )$$

$$and ,$$

$${LF}_{k}^{1 , r} = ϕ ( {w}_{0 k}^{1} + {w}_{i k}^{1} {v}_{i}^{r} + {w}_{j k}^{1} {v}_{j}^{r} ) \qquad ( 4. b )$$

Where,

$${v}_{i}^{r} and {v}_{j}^{r}$$

are the values of the i^{th} and j^{th} variables of the record r and the weights

$${w}_{0 k}^{1} , {w}_{i k}^{1} and {w}_{j k}^{1}$$

are defined in the step above during model training as per equation (3.a) and (3.b).

Next, the activation threshold, θ, is defined to determine whether each of the interpretable latent feature,

$${LF}_{k}^{1} ,$$

has fired or not. If the value of the latent feature is above a pre-determined threshold the latent feature is considered to have fired as shown per equation (2) and as shown in figure (2.a). The resultant binary indicator variables are referenced as

$${I}_{k}^{1} .$$

While a single activation threshold value is commonly used, in some embodiments, different thresholds for different iterations can be utilized to yield better selection of latent features leading to higher detection of minority class while lower misclassification of majority class.

This process of determining the values of latent features and whether they have fired or not is easily automated in a spark job or other parallelization approach to speed up the determination of firing of each of the interpretable latent feature,

$${LF}_{k}^{1}$$

on the training dataset. The resultant dataset looks like the schematic in FIG. 2b.

FIG. 2a is a diagram illustrating the values of generated interpretable latent features for a single record, compared against a fixed activation threshold, θ. In this example, the value of latent feature LF₂¹ for this particular record is higher than the threshold and hence it is considered to be firing for the particular record, in accordance with one or more embodiments of the current subject matter.

FIG. 2b is a diagram illustrating the first six records of the dataset D¹, with binary indicators showing whether each of the corresponding latent features is above or below the activation threshold, in accordance with one or more embodiments of the current subject matter.

FIG. 2c is a diagram illustrating the transformed dataset D¹_{LF}, comprising binary indicators

$${I}_{k}^{1}$$

for each record. In this schematic, data is represented in a comma-separated format, where the first column represents a record ID and the rest of the columns represent the firing (or lack of firing) of each latent feature, in accordance with one or more embodiments of the current subject matter.

FIG. 2d is a diagram illustrating the dataset with class labels for each of the records. A value of 1 indicates the minority class, and a value of 0 indicates the majority class, in accordance with one or more embodiments of the current subject matter.

FIG. 2e is a diagram illustrating two subsets of the data. The subset on top represents D¹_{LF_minority} and includes records #1, #4, #6, etc. The subset on the bottom represents D¹_{LF_majority} and includes records #2, #3, #5, etc. For ease of representation, input variables are not shown in the schematic diagrams, but they are present in the datasets, in accordance with one or more embodiments of the current subject matter.

This transformation of the uncovered dataset D¹ yields a dataset, D¹_{LF}, comprising of binary indicators as shown schematically in FIGS. 2b and 2c. In some embodiments, the interpretable latent features,

$${LF}_{k}^{1} ,$$

may nor be retained in this dataset, D¹_{LF}, for memory optimization but the process may continue to retain the input variables in this dataset. Using the class labels, as shown in FIG. 2d, the dataset D¹_{LF} can be partitioned into two datasets, D¹_{LF_minority} and D¹_{LF_majority} corresponding to all instances of minority and majority classes respectively as shown in FIG. 2e. This is done for ease of computation and is especially helpful when using a spark job or similar parallelization approach to speed up the computation.

### Selecting Interpretable Latent Feature Based on Class Coverage

When a binary classification model is trained, its goal is to separate the two classes to the greatest extent possible. In the identification of minority class instances, the objective is to maximize the detection of the minority class while minimizing false positives in the majority class. This is traditionally achieved by using a cost function that measures how well the model can predict the actual values, with the minority class represented by a numerical value of 1 and the majority class by a numerical value of 0. By iteratively minimizing the cost function, the weights of the model are adjusted to improve the accuracy of the predictions.

Keeping this objective of model training in mind, the interpretable latent feature that maximizes the detection of minority class instances while minimizing the false positives of majority class instances must be selected. Various metrics can be used to operationalize the selection of interpretable latent features focused on minority class detection while minimizing majority class misclassification. An example metric is shown in Equation (5.a), referred to as the Coverage Efficiency of the latent feature

$${LF}_{k}^{p} .$$

This measurement is carried out on the holdout dataset, D_{H}.

$${CoverageEfficiency}_{k}^{p} = log ( \frac{( \% of instances of minority class when {I}_{k}^{p , r} = 1 ) + c}{( \% of instances of majority class when {I}_{k}^{p , r} = 1 ) + c} ) \qquad ( 5. a )$$

$${CoverageEfficiency}_{k}^{p} = log ( \frac{\frac{{N}_{minority}^{p} when {I}_{k}^{p , r} = 1}{{N}_{minority}^{p}} + c}{\frac{{N}_{majority}^{p} when {I}_{k}^{p , r} = 1}{{N}_{majority}^{p}} + c} )$$

Where

$${N}_{minority}^{p}$$

represents number of minority instance, and

$${N}_{majority}^{p}$$

represents number of majority instance in the uncovered dataset D¹. The constant c, in both the numerator and denominator is called a smoothing constant. It is often set to a low value and equivalent to a tiny fraction of the population. Incorporating this smoothing constant nudges the selection of the class coverage latent feature towards those which lead to larger number of cases being detected.

Computation of this metric is straightforward and computationally easy when the data is already represented in the form as shown previously in figure (2.e). For a given column representing an interpretable latent feature, the cases where the values are “1” for both datasets are counted, D^{p}_{LF_minority} and D^{p}_{LF_majority} representing minority and majority class instances. This process is automated using a spark job or other parallelization step to speed up the computation of

$${CoverageEfficiency}_{k}^{p}$$

for each of the either 1-variable or 2-variable interpretable latent feature,

$${LF}_{k}^{p} .$$

Each spark job corresponds to one latent feature,

$${LF}_{k}^{p}$$

in the p^{th} iteration.

In the first iteration of the algorithm, a

$${CoverageEfficiency}_{k}^{1}$$

for each of the interpretable latent feature,

$${LF}_{k}^{1} ,$$

may be computed using the equation (5.a). The first selected interpretable latent feature, also called the first class coverage latent feature, is the latent feature that has the largest value of

$${CoverageEfficiency}_{k}^{1} .$$

Without loss of generality, let us call this latent feature LF¹.

$$L {F}^{1} = L {F}_{m}^{1} where , m = arg {max}_{k} ( {CoverageEfficiency}_{k}^{1} ) \qquad ( 5. b )$$

Thus, the class coverage latent feature LF¹ fires on an optimal number of minority class instances while firing on fewer majority class instances. The instances of minority class that the latent feature fires on are true positive cases and the instances of majority class that the latent feature fires on are false positive cases. Note that this may not always be the latent feature that fires on the maximum number of minority class instances.

At this stage, all the instances of records for which the latent feature LF¹ fired are labeled as ‘covered’ as they would be activated on by the first selected interpretable latent feature, LF¹. For the ease of reference, the binary indicator corresponding to LF¹ is referred as I¹ and the value of this indicator variable for record r as l^{1,r}. Then the false positive ratio (FPR) corresponding to the selected latent feature LF¹ is computed as follows:

$${FPR}_{{LF}^{1}} = \frac{{N}_{majority}^{1} when {I}^{1 , r} = 1}{{N}_{minority}^{1} when {I}^{1 , r} = 1} \qquad ( 6. a )$$

$${N}_{majority}^{1} and {N}_{minority}^{1}$$

represent the count of majority and minority instances respectively in the first iteration. Thus

$${N}_{majority}^{1}$$

when I^{1,r}=1 is the count of majority class instances for which the latent feature, LF¹, fires and

$${N}_{minority}^{1}$$

when I^{1,r}=1 is the count of the minority class instances for which the latent feature, LF¹, fires.

In some embodiments, the latent feature LF¹ is selected if, based on FPR_{LF}_{₁}, as per equation (6.a), the condition as shown in equation (6.b) is met.

$${FPR}_{L {F}^{1}} < {T}_{FPR} \qquad ( 6. b )$$

Where T_{FPR} is the acceptable threshold for false positive rate and is often determined by operational constraints. It is also a function of rarity or prevalence of the minority class instances.

If this stopping criterion is not violated, then LF¹ becomes the first entry in the set of selected class coverage latent features, LF_{selected}. In some embodiments, the detection rate (DR) of the selected latent feature, LF¹, is then computed on the original holdout dataset, D_{H}.

$${DR}_{L {F}^{1}} = \frac{{N}_{minority}^{1} when {I}^{1 , r} = 1}{{N}_{minority}} \qquad ( 6. c )$$

N_{minority} represents the total count of minority instances in the entire dataset.

Using the smoothing constant in the computation of coverage efficiency ensures that interpretable latent features with just one instance of the majority and one instance of the minority cases are not selected, which ensures that the false positive rate computes to reasonable values. In the subsequent iterations described in later sections, the computation of the false positive rate and detection rate are cumulative of all selected class coverage-based latent features in a waterfall approach, ensuring that the degenerate case of one majority and one minority instance is avoided.

A method is now available for separating minority class and majority class instances in the dataset D¹ with optimal number of true positives and false positives based on the firing of latent feature LF¹. All interpretable latent features, including the selected LF¹, are positively correlated with the outcome variable and LF¹ is selected from the pool of candidate latent features based on the largest value of

$${CoverageEfficiency}_{k}^{1} .$$

This leads to good detection of minority instances based on equation (6.c) while keeping the detection rate below the threshold as per equations (6.a) and (6.b). In the subsequent iterations, the termination condition based on the FPR constraint ensures that the algorithm comes to a stop if too few true positives or too many false positives are encountered.
Partitioning of the Data Space Based on Coverage Latent Feature with Maximum Coverage Efficiency

Two datasets, D¹_{LF_minority} and D¹_{LF_majority} corresponding to all instances of minority and majority classes respectively, have been defined. In some embodiments, using these datasets, it has been identified how each of the interpretable latent features fire on both the datasets. This allowed us to identify the first latent feature LF¹, which partitions each of the two datasets into two subsets-one covered and one uncovered. For the covered population, there is now a way to separate minority class and majority class instances with an optimal number of true positives and fewer false positives based on the firing of latent feature LF¹. Therefore, in some embodiments, the covered population is discarded, and the uncovered population is retained for both the minority and majority classes.

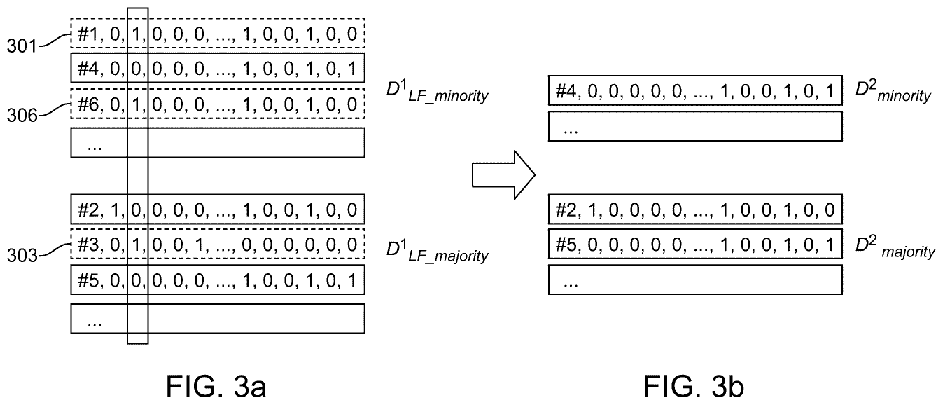

Let the resultant uncovered population be named as D²_{minority} and D²_{majority}, corresponding to all instances of minority and majority classes respectively for which latent feature LF¹ did not fire. Note the subtle difference in the nomenclature—the names of the resultant uncovered datasets do not have “LF” in their subscript. In some embodiments, this process of partitioning the dataset to generate the uncovered dataset is shown in FIGS. 3a and 3b.

FIG. 3a is a diagram illustrating a subset of the records identified based on the firing of the highest coverage-based latent feature, LF¹. The column representing LF¹ firing is shown by the vertical box. The records where LF¹ fired are shown in dotted records 301, 306 and 303. These records represent the population covered by LF¹, in accordance with one or more embodiments of the current subject matter.

FIG. 3b is a diagram illustrating the removal of the covered records from further consideration, with the uncovered population represented by D²_{minority} and D²_{majority}, in accordance with one or more embodiments of the current subject matter.

All the indicator variables are dropped from these two datasets along with the latent features, if present, while retaining only the input variables. The datasets are still called D²_{minority} and D²_{majority} respectively.

These resultant datasets are then joined with the tags, merged together, and named as D². This combined dataset represents the uncovered population that was not covered by the selected coverage latent feature on the previous dataset D¹. With the creation of this dataset, the first iteration of the algorithm is complete.

The algorithm is then repeated on this uncovered dataset D². In some embodiments, D²_{minority} and D²_{majority} are utilized for efficiency. In the second and subsequent iterations, D^{p}_{minority} and D^{p}_{majority} are used along with D^{p} for efficiency.

### Subsequent Iterations

In general, during the p^{th} iteration, the uncovered dataset D^{p} generated at the end of the previous iteration, p−1, is used to learn a new set of the interpretable latent features using equations (3.a) and (3.b). Care is taken to ensure that the newly learnt interpretable latent features are not based on the same variable or variables pair which already define the set of selected class coverage latent features, LF_{selected}. Let the k^{th} resultant latent feature be annotated as

$$L {F}_{k}^{p} .$$

Once the interpretable latent features,

$${LF}_{k}^{p}$$

are learnt, their values need to be determined. Unlike in the first iteration, the process works directly with D^{p}_{minority} and D^{p}_{majority} generated in the previous iteration to compute

$${LF}_{k}^{p , r} ,$$

which is the latent feature activation value of

$${LF}_{k}^{p}$$

for the r^{th} record, using the equation (4.c) and (4.d) expressed for a given record, r.

$${LF}_{k}^{p , r} = ϕ ( {w}_{0 k}^{p} + {w}_{i k}^{p} {v}_{i}^{r} ) \qquad ( 4. c )$$

$$and$$

$${LF}_{k}^{p , r} = ϕ ( {w}_{0 k}^{p} + {w}_{i k}^{p} {v}_{i}^{r} + {w}_{j k}^{p} {v}_{j}^{r} ) \qquad ( 4. d )$$

In some embodiments, the binary indicator variables

$${I}_{k}^{p , r}$$

may then be computed using equation (2) corresponding to activation of the latent features

$${LF}_{k}^{p , r}$$

on D^{p}_{minority} and D^{p}_{majority} to yield the datasets D^{p}_{LF_minority} and D^{p}_{LF_majority}. This approach allows for more efficient implementation compared to computing the values of the interpretable latent features and binary indicators directly on D^{p} and subsequently splitting up the dataset to generate these subsets. This iterative approach allows the selection of additional interpretable latent features on the uncovered population, which are then added to the covered population. This process is repeated to select additional latent features until the condition specified by equation (6.e) is not met. At that point, the last selected latent feature is discarded, and the iterations are stopped.

For the iterative selection of class coverage latent features, equations (6.a), (6.b), and (6.c) take the following form with respect to the uncovered datasets D^{p}_{LF_minority} and D^{p}_{LF_majority}.

$${FPR}_{{LF}_{selected}} = \frac{{\sum }_{p} [ {N}_{majority}^{p} when {I}_{k}^{p , r} = 1 ]}{{\sum }_{p} [ {N}_{majority}^{p} + {N}_{majority}^{p} when {I}_{k}^{p , r} = 1 ]} \qquad ( 6. d )$$

$${FPR}_{{LF}_{selected}} < {T}_{FPR} \qquad ( 6. e )$$

$${DR}_{{LF}_{selected}} = \frac{{\sum }_{p} {N}_{majority}^{p} when {I}^{p , r} = 1}{{N}_{majority}} \qquad ( 6. f )$$

Note the presence of summation in equations (6.d) and (6.f). This is due to the waterfall approach, where, from the first selected latent feature to the last selected latent feature, the number of instances of majority and minority class instances identified by the latent features is determined, i.e., the records that are covered by those latent features. This waterfall approach leads to discrete values of detection rate and false positive rate s. Also note that the term LF_{selected} represents the selected coverage-based latent features.

At the end of the p^{th} iteration, the selected latent feature with most effective coverage is given by:

$${LF}^{p} = {LF}_{m}^{p} where , m = arg {max}_{k} ( {CoverageEfficiency}_{k}^{p} ) \qquad ( 6. g )$$

If this stopping criterion (6.e) is not violated, then the latent feature LF^{p} becomes the newest entry in the set of selected class coverage latent features, LF_{selected}. When the condition (6.e) is not met, the latent feature, LF^{p} is discarded and the process is left with a set of {LF¹, LF², . . . , LF^{p-1}} as the selected coverage based latent features, LF_{selected}.

The method described so far generates a set of interpretable latent features from the space of combinations of possible single and pairwise latent features generated from an ever-shrinking uncovered dataset. These features maximize the coverage efficiency metric while remaining within the stopping criteria based on the stated operating threshold for the final model, given by equation (6.e) or similar. This set of interpretable latent features is referred to as the set of class coverage latent features.

### Identifying Slack Latent Features

At the end of the last iteration, p, the process is left with the uncovered dataset D^{p} and a set of latent features

$${LF}_{k}^{p}$$

where no latent feature was selected to be added to the set of class coverage latent features due to violation of the termination criterion given by equation (6.e). In some embodiments, this uncovered dataset has remaining instances of minority class which have not been detected by the set of class coverage latent features. To help with detection of minority class instances in the remaining uncovered dataset, a set of slack latent features are generated. These slack latent features are selected from the set of latent features generated in the last iteration,

$${LF}_{k}^{p} .$$

By virtue of how these latent features are learnt, they are not based on the same variable or variables pair which already define the set of selected class coverage latent features, LF_{selected}.

To identify the candidates for slack latent features, the process may start with the uncovered dataset, D^{p}. The latent features

$${LF}_{k}^{p}$$

are used as the starting set of predictors and train a small model to predict the class variable. A typical way to train such a model with uncovered latent features as the input set would require us to use the cost function as shown in equation 7.

$$C ( w ) = \frac{1}{2 ρ} {\sum }_{r} {‖ y ( r ) - a ( r ) ‖}^{2} \qquad ( 7. a )$$

Where, w represents the set of weights connecting the latent features to the output node, r is the record, y is the actual class value and a is the predicted class, or more accurately probability of being the minority class.

A small subset of the latent features without coverage that maximizes detection of the minority class is identified on the uncovered dataset, D^{p}. A simple way to keep this model small and select a small subset of latent features is to apply Least Absolute Shrinkage and Selection Operator (LASSO) regularization while training the small model. This is done by using the modified cost function as shown in equation 7.b:

$${C}^{′} ( w ) = \frac{1}{2 ρ} {\sum }_{r} {‖ y ( r ) - a ( r ) ‖}^{2} + \frac{λ}{ρ} \sum \vert w \vert \qquad ( 7. b )$$

The resultant model has a small set of latent features, without necessarily meeting coverage criteria, which are the best set of predictors for detecting the minority class instances in the dataset without coverage. Let the latent features selected as slack latent features be referenced as

$${LF}_{s}^{n} ,$$

where

$${LF}_{s}^{n}$$

represents the n^{th} slack latent feature selected as the predictor in the slack model.

### Training the Interpretable Latent Feature Machine Learning Model

The interpretable latent feature architecture is defined by using the identified set of class coverage latent features as the primary set of latent features in a neural network model. Collaboration between these class coverage latent features can further increase the detection rate while maintaining and, in many cases, even improving the false positive rate. Additionally, the use of slack latent features improves the detection of minority class instances that the class coverage latent features fail to detect. Adding slack latent features to the neural network model enhances generality for any minority class instances not identified by the class coverage-based selection method.

Let LF^{k} represent the k^{th} coverage latent feature being transferred to the neural network. Further, let

$${LF}_{s}^{n}$$

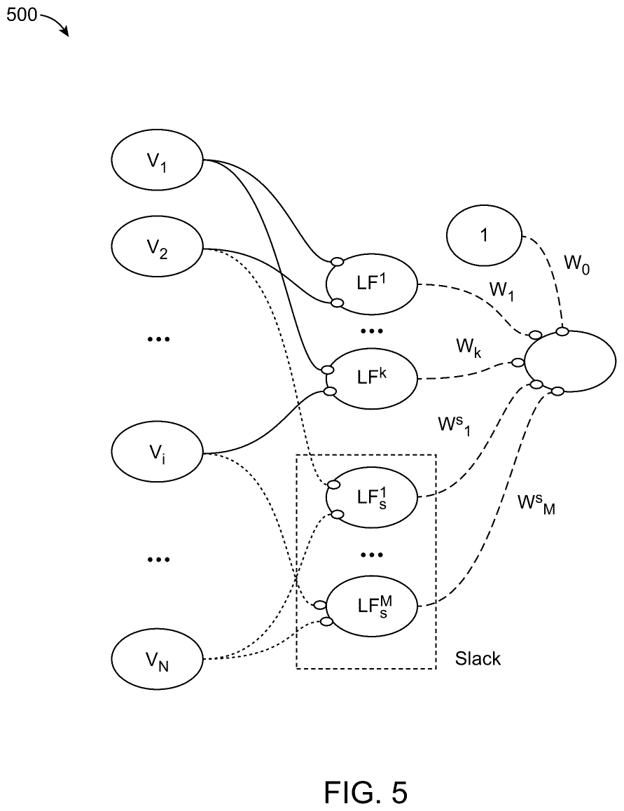

represents the n^{th} slack latent feature. In some embodiments, both the set of class coverage latent features as well as the set of slack latent features are transferred to the neural network model shown in FIG. 5.

During neural network model training, the transferred weights of the edges connecting the input variables to the transferred latent features are used as the starting values of their weights. These weights can either be fixed or allowed to be re-learned. The neural network model is then trained on the original training dataset to predict the class variable. When the transferred weights are kept fixed, only the weights of the edges connecting the latent features to the output node are updated during training.

FIG. 5 is a representation of a highly interpretable latent feature neural network architecture based on class coverage latent features transferred using guided AI, along with a set of slack latent features whose weights are controlled using the slack constraint. The class coverage latent features are the set of latent features selected using the selection algorithm described in the previous section. Slack latent features are selected from a simple model that maximizes detection on uncovered data. The weights of the edges shown in solid and dotted can be either transferred using guided AI or re-learned as part of the model training, in accordance with one or more embodiments of the current subject matter.

Let wₖ be the weight of the edge connecting LF^{k} to the output node and

$${w}_{n}^{s}$$

be the weight of the edge connecting

$${LF}_{s}^{n}$$

to the output node and w₀ be the bias term into the output node. While training the neural network model, the following constraints are applied, called slack constraint as given by equation (8).

$$\frac{\sqrt{{\sum }_{n} {( {w}_{n}^{s} )}^{2}}}{\sqrt{{( {w}_{0} )}^{2} + {\sum }_{k} {( {w}_{k} )}^{2} + {\sum }_{n} {( {w}_{n}^{s} )}^{2}}} < δ \qquad ( 8 )$$

where δ is the slack threshold and controls the amount of weight contribution that the slack latent features can have. This is done to ensure that slack does not adjust to learn alternate representations already covered in the selected coverage-based latent features. The resultant model is the interpretable latent feature architecture based on class coverage using the specified model architecture and connections.

The neural network training begins with the weights that define the class coverage latent features, the solid edges, and the weights that define the slack latent features, the dotted edges. While training the neural network, either only the weights of the edges connecting the latent features to the output node/layer, shown as dashed edges, are allowed to be adjusted, or a combination of weights of edges connecting latent features to the output node and the edges defining the slack latent features to adjust, shown as dashed and dotted edges. Care is taken to ensure that the weights that define the class coverage latent features (i.e., shown as solid edges) are not updated or adjusted.

If the weights of the input variables to the corresponding slack latent features are updated, only the structural relationships between the input variables and the slack latent features are preserved while relearning the nature and definitions of the slack latent features. Keeping the weights of these edges fixed or allowing them to be updated is a matter of analytic choice based on whether to preserve only the structural aspect of these slack latent features or to preserve their full nature.

In some embodiments, transfer learning provides the mechanism for controlling which set of edges can be updated and which cannot. Furthermore, by applying the constraint specified by equation (8), the resultant neural network maximizes the combined effect of the class coverage latent features while the slack latent features generalize the model on the population that is uncovered by the class coverage latent features.

An additional advantage of using the interpretable latent feature machine learning model architecture based on class coverage is that it provides a continuous score that allows for better control on the false positive thresholds. This contrasts with the waterfall approach of using the class coverage latent features for minority class detection, where cases are detected based on the firing of the class coverage-based interpretable latent features one by one. This leads to discrete values of detection rate and false positive rates. Using the continuous score, an operating threshold that satisfies the criterion specified by equation (6.b) can be identified, allowing operation very close to the value of T_{FPR}.

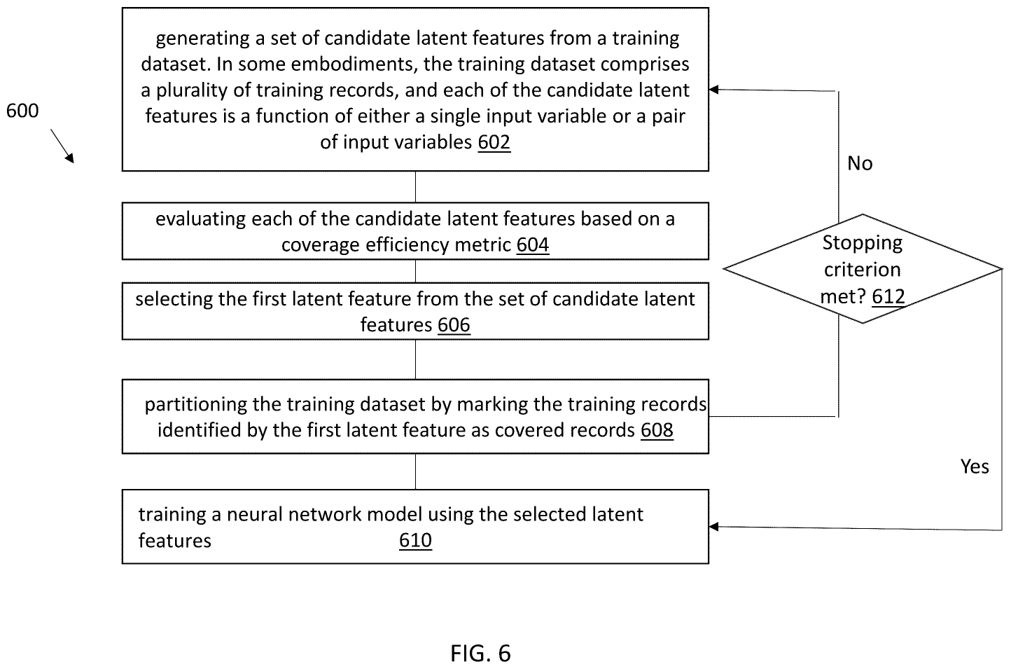

FIG. 6 is a diagram illustrating a flow chart of a process 600 for generating a classifier, in accordance with one or more embodiments of the current subject matter. As shown in FIG. 6, the process 600 may begin with operation 602, wherein the system may generate a set of candidate latent features from a training dataset. In some embodiments, the training dataset comprises a plurality of training records, and each of the candidate latent features is a function of either a single input variable or a pair of input variables. In some embodiments, the initial training dataset is the initial set of uncovered datasets. Next, in operation 604, the system may evaluate each of the candidate latent features based on a coverage efficiency metric. In some embodiments, the coverage efficiency metric balances detection of minority class instances against a minimization of false positives among majority class instances. In operation 606, the system may select the first latent feature from the set of candidate latent features based on a ranking of the coverage efficiency metric associated with each of the candidate latent features. The process 600 may then advance to operation 608, wherein the system partitions the training dataset by marking the training records identified by the first latent feature as covered records and removing the covered records from the training dataset to form an uncovered dataset. The process 600 may iteratively repeat the operations of generating candidate latent features, evaluating coverage efficiency, selecting latent features, and partitioning the remaining training dataset in multiple iterations until a predefined stopping criterion is met. In some embodiments, the predefined stopping criterion comprises a threshold for false positive rate and a condition for improvement in a detection rate of minority class instances. For example, at operation 612, the system may determine if the stopping criterion is met. If not, the process returns to operation 602 to continue with the next iteration. If yes, the process proceeds to operation 610. In operation 610, the system may train a neural network model using the selected latent features. In some embodiments, training the neural network model further comprises identifying a set of slack latent features from the remaining candidate latent features to capture minority class instances not detected by the selected latent features. The slack latent features may be selected based on an ability to improve the detection rate in the uncovered dataset. In some embodiments, training the neural network model using both the selected latent features and the slack latent features involves constraining the contribution of slack latent features. In some embodiments, training the neural network model further comprises retrieving a first set of weights associated with the selected latent features indicating relationships between an input layer and the selected latent features, and retrieving a second set of weights associated with the slack latent features indicating relationships between the input layer and the slack latent features. In some embodiments, training the neural network model involves determining weights from the selected latent features and the slack latent features, wherein the first set of weights are not adjusted during the training process. In some embodiments, the predefined stopping criterion further comprises a determination that an addition of newly-selected latent features does not result in an improvement in model performance, measured by an increase in the detection rate of minority class instances while maintaining the false positive rate below the threshold. In some embodiments, evaluating each of the candidate latent features based on a coverage efficiency metric further comprises generating an activation dataset. The activation dataset may include binary indicators for each of the training records and each of the candidate latent features, indicating whether a latent feature fires for a training record based on an activation threshold corresponding to the latent feature. In some embodiments, the activation threshold is adjusted based in part on a specific iteration of the multiple iterations. In some embodiments, the process may further comprise combining multiple selected latent features into composite features, wherein the composite features are created based in part on synergistic interactions between the selected latent features.

### Use Case

The methodology and approaches described herein can be applied to multiple real-life datasets across various use cases, such as credit risk and fraud detection, and has demonstrated strong model performance compared to fully connected dense neural networks while providing simplicity and interpretability due to a minimal number of interpretable latent features constituting the model. In this section, the work done and the consequent results from one such experiment are described. The methodology and approach was evaluated on a fraud dataset consisting of 1.73 million records with 3,793 instances of fraud, which represents ˜0.2% of the total population in the dataset. In this use case, fraud is the minority class. Each record was labeled to belong either to the minority class (fraud) or the majority class (non-fraud). This development dataset was subsequently split into training and holdout datasets for training and testing of machine learning models, as per the usual practice. An out-of-time dataset with 495 thousand records and 852 instances of fraud, also ˜0.2% of the total, was used for out-of-time model performance evaluation to demonstrate the robustness of the model. These datasets are production-grade data based on contributed payment card fraud data across various banks.

A subset of 10 input variables was used as the starting point. Initially, the non-fraud cases in the development dataset were down-sampled using a stratified random sampling technique. This is a standard analytic practice when the proportion of minority class instances is too low compared to the majority class instances. When employing down-sampling, it is important to account for this adjustment while computing metrics such as false positive rate, which can be impacted if the metrics are not calculated on the original population. Metrics such as coverage efficiency and detection rate are invariant to down-sampling, but false positive rate is influenced if the down-sampling rate is not considered. These metrics are described by a set of equations (5) and (6). Failing to pay attention to this aspect may cause the algorithm to terminate either too early, leaving many predictive latent features unselected, or too late, resulting in the selection of many latent features. Both scenarios would lead to a suboptimal model, impacting its predictive power.

After down-sampling, the dataset was split into a training dataset and a holdout dataset as mentioned earlier. Then, a fully dense neural network model was created using the training dataset with the class labels acting as the target variable. Using hyperparameter search, the best number of hidden nodes to be used in the model was determined, which happened to be 20 hidden nodes in this instance. The resultant architecture, despite its relative simplicity due to only 10 input variables, had 241 parameters representing the weights and bias terms for each of the dense hidden nodes and the output node. Once the model was trained, its performance was measured on its ability to separate minority class instances from majority class instances on the holdout dataset, establishing a baseline performance. In this instance, a detection rate of 63.79% at a false positive rate of 10:1 on the in-time holdout dataset was achieved. This model was then tested on the out-of-time dataset, achieving a detection rate of 62.93% at a false positive rate of 10:1. The model was high performing but not robust enough. The goal then was to achieve a performance as close as possible to this model's using the algorithm and obtain a model that is more robust.

To produce a set of interpretable latent features and subsequently train the interpretable latent feature architecture based on class coverage, pairwise latent features were generated using all possible pairs of the 10 input variables on the training dataset. This was done by taking each input variable and subsequently each pair of input variables as predictors and training a small model using the class labels as the target variable. Using equation (3.a) yielded 10 latent features, which are nonlinear transformations of each of the 10 input variables. Using equation (3.b) provided another 45 pairwise latent features, which are the interaction terms for each pair of input variables. Altogether, a total of 55 candidate interpretable latent features were obtained.

For each of the records in the training dataset, the activation values of each of the 55 latent features were then computed using equations (4.a) and (4.b). By utilizing equation (2) along with a single activation threshold value, it was determined whether each of the latent features fired or not for each of the records. To determine the best value of the activation threshold, θ, the entire experiment was run multiple times with different threshold values to arrive at the final interpretable latent feature machine learning model based on class coverage with the best performance value. This yielded the optimal value of activation threshold, and the subsequent section describes the results in the context of this optimal activation threshold. As such, activation threshold, θ, is a hyperparameter of the algorithm.

After applying the activation threshold to determine whether each of the latent features fired or not, the training dataset was split into two subsets for minority and majority class instances, D¹_{LF_minority} and D¹_{LF_majority}. The coverage efficiency for each of the latent features was then computed, as defined by equation (5.a), with p=1 representing the first iteration. The first selected interpretable latent feature, LF¹, was the one that had the largest value of coverage efficiency as per equation (5.b). The false positive rate was then computed using equation (6.a) with the counts adjusted for the down-sampling rate. It was ensured that the computed false positive rate was lower than an acceptable false positive rate, TFPR, as per equation (6.b). Note that the false positive threshold is often determined by operational constraints and is also a function of the rarity or prevalence of the minority class instances. Finally, equation (6.c) allowed for the computation of the detection rate attributable to this first coverage-based latent feature, LF¹.

Once the first coverage-based latent feature, LF¹, was identified, all the records for which this latent feature had fired were marked and removed from the D¹_{LF_minority} and D¹_{LF_majority} datasets, resulting into new datasets, D²_{minority} and D²_{majority}. The indicator variables and the latent features were then dropped, while retaining the input variables. These resultant datasets were then joined with the tags, and the resultant datasets were merged together and named as D². On dataset D² a new set of latent features was learned using equations (3.a) and (3.b). Care was taken to ensure that a latent feature based on the same input(s) as LF¹ was not learned. The best latent feature from the set of newly created latent features was then identified, ensuring that the false positive rate was acceptable. Equations (5.a), (6.d), and (6.f) were used to compute coverage efficiency, false positive rate, and detection rate, respectively. Equation (6.e) was used to determine whether the acceptable false positive rate was maintained. This entire process was repeated iteratively until the condition set by equation (6.e) was breached.

Eight class coverage-based interpretable latent features were selected before failing to meet the false positive threshold criterion specified by equation (6.e). All eight selected latent features were based on two input variables. Using these eight class coverage-based interpretable latent features on the holdout dataset, the waterfall approach via equation (6.f) was used to compute the detection rate, and equation (6.d) was used to compute the false positive rate. This method detected 56.69% of fraud instances in the holdout dataset at a false positive rate lower than 10:1, with only 24 parameters required to meet this detection level. Testing on the out-of-time dataset using the waterfall approach detected 58.92% of fraud instances at a false positive rate lower than 10:1. In comparison, a fully connected neural network had a detection rate of 62.93% on the holdout dataset at the same false positive rate, requiring 241 parameters. Thus, the simple waterfall approach closely approximated the performance of a fully dense neural network model with significantly fewer parameters, using only 24 parameters, equivalent to three weights each for the eight class coverage-based interpretable latent features. This compared favorably to 241 parameters for the fully dense neural network.

After selecting the interpretable latent features based on class coverage while meeting the false positive threshold criterion, the uncovered dataset and the last set of unselected latent features trained on this uncovered dataset remained. These latent features presented an opportunity to improve detection further while maintaining the false positive threshold. The minority and majority class subsets were merged, ensuring that each record was identified as belonging to the correct class. Care was taken after each iteration to ensure that no latent feature was learned based on the same input(s) as the already selected class coverage-based interpretable latent features. A small neural network model was trained with the interpretable latent features as potential predictors and class definition as the target variable, with LASSO regularization applied during model training as per equation (7.b). This resulted in a small neural network with three interpretable latent features, which were used as slack latent features for the subsequent training of the interpretable latent feature machine learning model based on class coverage. All three selected slack latent features were 2-variable latent features. A guided AI approach was used to train an interpretable neural network with the eight selected class coverage latent features as primary latent features and the three additional slack latent features. The weights of the edges connecting the input variables to the transferred latent features were transferred. Each of the transferred latent features was connected to the output node, and the architecture resembled the schematic shown in FIG. 5. Two sets of experiments were conducted. In one set, only the weights connecting the transferred latent features to the output node were allowed to be updated during model training while applying the slack constraint as per equation (8). In another experiment, the weights of the slack latent features were also updated during model training, with the transferred weights of the slack latent features as their starting points. In both experiments, the transferred weights of the primary latent features were kept fixed while training the model. Various values of slack constraints were experimented with, and a small slack constraint of 8% was found to be optimal for model performance in both scenarios. The resultant models were then used to score the holdout and out-of-time datasets. The detection rate of both models was measured at the desired false positive rate of 10:1. The model with the fixed weights of the transferred latent features had a detection rate of 61.07% on the holdout dataset and 64.23% on the out-of-time dataset. The model where the weights of the slack latent features were updated had a detection rate of 61.23% on the holdout dataset and 64.08% on the out-of-time dataset. Based on these results, it was concluded that for this class of problem, the extra effort of relearning the weights of the edges defining the interpretable latent features did not translate into extra detection of the minority class on the holdout dataset.

This detection rate of 61.07% on the holdout dataset, while maintaining the false positive rate under the desired 10:1, compares favorably to the detection rate of the fully connected neural network model at 63.79% on the same holdout dataset. Moreover, on the out-of-time dataset, the class coverage-based interpretable latent feature machine learning model performs better, achieving a 64.23% detection rate compared to the fully dense neural network's 62.93% detection rate. With only 45 free parameters, this model's detection rate for such a class imbalance problem is remarkable, ensuring high interpretability. The comparative simplicity of the model becomes even more apparent when using a larger number of input variables.

TABLE 1
Comparing the performance of (a) the dense neural network model,
(b) the waterfall approach of using the class coverage based interpretable
latent features (ILF) and (c) class coverage based ILF model with
weights of primary and slack latent features fixed.

| | Detection rate at 10:1 | | |
|---|---|---|---|
| | false positive rate | | |
| | Holdout | Out of | |
| Model architecture | dataset | time dataset | Parameters |
| Dense neural network | 63.79% | 62.93% | 241 |
| Waterfall approach | 56.69% | 58.92% | 24 |
| Class coverage based | 61.07% | 64.23% | 45 |
| ILF machine learning | | | |

Note that the value of the activation threshold can significantly impact the results of the final model. This threshold is influenced by the sharpness of the gradients of the activation values of the latent features, which in turn are affected by the down-sampling rate of the non-fraud cases. The results presented here are for a down-sampling scenario where there were 10 non-fraud cases for every fraud case in the uncovered dataset during the training of the interpretable latent features in each iteration of the algorithm. The corresponding value of 0 used in the results shown here was a fixed value of 0.95.

This approach described herein creates a class coverage-based interpretable latent feature machine learning model with far fewer parameters than comparably performing fully dense neural networks. This interpretable neural network model has a single hidden layer where each latent feature is a function of either a single input variable or exactly two input variables. In some embodiments, a primary set of coverage-based interpretable latent features is selected based on class coverage on the training dataset while meeting a false positive threshold criterion. Additionally, a secondary set of latent features, selected as slack latent features, is used to maximize the detection of the uncovered population, further enhancing the detection of minority class instances. The contribution of these slack latent features may be capped. Furthermore, in some embodiments, the nature of the relationships captured by the slack latent features can either remain immutable or be relearned while training the full model architecture. The resultant model has similar predictive power as a fully connected dense neural network model while having fewer degrees of freedom. Moreover, the model is more robust than the fully dense neural network and performs better on the holdout dataset, which is important in real-life deployment of these models in production use cases and emphasizes how densely connected models are nearly always overtrained.

The application of this methodology on real-life use cases has produced compact and highly interpretable latent features with few input variables, a handful of interpretable latent features, and consequently fewer degrees of freedom while providing strong detection rates and robust performance even for high class imbalance scenarios. The simplicity of the model using a deliberate constructive approach based on maximizing class coverage with either 1-variable or 2-variable interpretable latent features allows for full transparency of the model, following the principles of Occam's razor that the simplest explanation is the best explanation. More importantly, this architecture demonstrates that transparency need not come at the cost of lower performance of the model. When this model is used out of time, it outperforms dense neural network models which are over-specified, leading to less frequent need for model retrains. With the increasing focus on transparency requirements, this methodology now provides a powerful way for businesses to construct high-performing yet transparent neural network models.

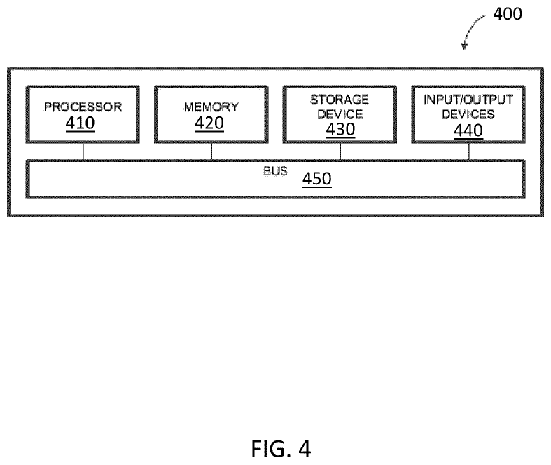

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for generating a classifier, comprising:
generating, by at least one processor, a set of candidate latent features from a training dataset, wherein the training dataset comprises a plurality of training records, and wherein each of the candidate latent features is a function of either a single input variable or a pair of input variables;
evaluating, by the at least one processor, each of the candidate latent features based on a coverage efficiency metric, wherein the coverage efficiency metric balances detection of minority class instances against a minimization of false positives among majority class instances;
selecting, by the at least one processor, a first latent feature from the set of candidate latent features based on a ranking of the coverage efficiency metric associated with each of the candidate latent features;
partitioning the training dataset by marking the training records identified by the first latent feature as covered records and removing the covered records from the training dataset to form an uncovered dataset;
iteratively repeating the steps of generating candidate latent features, evaluating coverage efficiency, selecting latent features, and partitioning remaining training dataset in multiple iterations until a predefined stopping criterion is met, wherein the predefined stopping criterion comprises a threshold for false positive rate and a condition for improvement in a detection rate of minority class instances; and
training a neural network classifier using the selected latent features.

2. The method of claim 1, further comprising:
identifying a set of slack latent features from remaining candidate latent features to capture minority class instances not detected by the selected latent features, wherein the slack latent features are selected based on an ability to improve detection rate in the uncovered dataset; and
training the neural network classifier using both the selected latent features and the slack latent features, wherein a contribution of slack latent features is constrained.

3. The method of claim 2, wherein training the neural network classifier further comprises:
retrieving a first set of weights associated with the selected latent features indicating relationships between an input layer and the selected latent features;
retrieving a second set of weights associated with the slack latent features indicating relationships between the input layer and the slack latent features; and
training the neural network classifier by determining weights from the selected latent features and the slack latent features,
wherein the first set of weights are not adjusted during the training the neural network classifier.

4. The method of claim 1, wherein the predefined stopping criterion further comprises a determination that an addition of newly-selected latent features does not result in an improvement in classifier performance, measured by an increase in the detection rate of minority class instances while maintaining the false positive rate below the threshold.

5. The method of claim 1, wherein evaluating each of the candidate latent features based on a coverage efficiency metric further comprises:
generating an activation dataset, wherein the activation dataset includes binary indicators for each of the training records and each of the candidate latent features, indicating whether a latent feature fires for a training record based on an activation threshold corresponding to the latent feature.

6. The method of claim 5, wherein the activation threshold is adjusted based in part on a specific iteration of the multiple iterations.

7. The method of claim 1, further comprising combining multiple selected latent features into composite features, wherein the composite features are created based in part on synergistic interactions between the selected latent features.

8. A computer program product comprising a non-transient machine-readable medium storing instructions that, when executed by at least one programmable processor, cause the at least one programmable processor to perform operations comprising:
generating, by at least one processor, a set of candidate latent features from a training dataset, wherein the training dataset comprises a plurality of training records, and wherein each of the candidate latent features is a function of either a single input variable or a pair of input variables;
evaluating, by the at least one processor, each of the candidate latent features based on a coverage efficiency metric, wherein the coverage efficiency metric balances detection of minority class instances against a minimization of false positives among majority class instances;
selecting, by the at least one processor, a first latent feature from the set of candidate latent features based on a ranking of the coverage efficiency metric associated with each of the candidate latent features;
partitioning the training dataset by marking the training records identified by the first latent feature as covered records and removing the covered records from the training dataset to form an uncovered dataset;
iteratively repeating the steps of generating candidate latent features, evaluating coverage efficiency, selecting latent features, and partitioning remaining training dataset in multiple iterations until a predefined stopping criterion is met, wherein the predefined stopping criterion comprises a threshold for false positive rate and a condition for improvement in a detection rate of minority class instances; and
training a neural network classifier using the selected latent features.

9. The computer program product of claim 8, wherein the operations further comprises:
identifying a set of slack latent features from remaining candidate latent features to capture minority class instances not detected by the selected latent features, wherein the slack latent features are selected based on an ability to improve detection rate in the uncovered dataset; and
training the neural network classifier using both the selected latent features and the slack latent features, wherein a contribution of slack latent features is constrained.

10. The computer program product of claim 9, wherein training the neural network classifier further comprises:
retrieving a first set of weights associated with the selected latent features indicating relationships between an input layer and the selected latent features;
retrieving a second set of weights associated with the slack latent features indicating relationships between the input layer and the slack latent features; and
training the neural network classifier by determining weights from the selected latent features and the slack latent features,
wherein the first set of weights are not adjusted during the training the neural network classifier.

11. The computer program product of claim 8, wherein the predefined stopping criterion further comprises a determination that an addition of newly-selected latent features does not result in an improvement in classifier performance, measured by an increase in the detection rate of minority class instances while maintaining the false positive rate below the threshold.

12. The computer program product of claim 8, wherein evaluating each of the candidate latent features based on a coverage efficiency metric further comprises:
generating an activation dataset, wherein the activation dataset includes binary indicators for each of the training records and each of the candidate latent features, indicating whether a latent feature fires for a training record based on an activation threshold corresponding to the latent feature.

13. The computer program product of claim 12, wherein the activation threshold is adjusted based in part on a specific iteration of the multiple iterations.

14. The computer program product of claim 8, wherein the operations further comprise combining multiple selected latent features into composite features, wherein the composite features are created based in part on synergistic interactions between the selected latent features.

15. A system comprising:
a programmable processor; and
a non-transient machine-readable medium storing instructions that, when executed by the processor, cause the at least one programmable processor to perform operations comprising:
generating, by at least one processor, a set of candidate latent features from a training dataset, wherein the training dataset comprises a plurality of training records, and wherein each of the candidate latent features is a function of either a single input variable or a pair of input variables;
evaluating, by the at least one processor, each of the candidate latent features based on a coverage efficiency metric, wherein the coverage efficiency metric balances detection of minority class instances against a minimization of false positives among majority class instances;
selecting, by the at least one processor, a first latent feature from the set of candidate latent features based on a ranking of the coverage efficiency metric associated with each of the candidate latent features;
partitioning the training dataset by marking the training records identified by the first latent feature as covered records and removing the covered records from the training dataset to form an uncovered dataset;
iteratively repeating the steps of generating candidate latent features, evaluating coverage efficiency, selecting latent features, and partitioning remaining training dataset in multiple iterations until a predefined stopping criterion is met, wherein the predefined stopping criterion comprises a threshold for false positive rate and a condition for improvement in a detection rate of minority class instances; and
training a neural network classifier using the selected latent features.

16. The system of claim 15, wherein the operations further comprise:
identifying a set of slack latent features from remaining candidate latent features to capture minority class instances not detected by the selected latent features, wherein the slack latent features are selected based on an ability to improve detection rate in the uncovered dataset; and
training the neural network classifier using both the selected latent features and the slack latent features, wherein a contribution of slack latent features is constrained.

17. The system of claim 16, wherein training the neural network classifier further comprises:
retrieving a first set of weights associated with the selected latent features indicating relationships between an input layer and the selected latent features;
retrieving a second set of weights associated with the slack latent features indicating relationships between the input layer and the slack latent features; and
training the neural network classifier by determining weights from the selected latent features and the slack latent features,
wherein the first set of weights are not adjusted during the training the neural network classifier.

18. The system of claim 15, wherein the predefined stopping criterion further comprises a determination that an addition of newly-selected latent features does not result in an improvement in classifier performance, measured by an increase in the detection rate of minority class instances while maintaining the false positive rate below the threshold.

19. The system of claim 15, wherein evaluating each of the candidate latent features based on a coverage efficiency metric further comprises:
generating an activation dataset, wherein the activation dataset includes binary indicators for each of the training records and each of the candidate latent features, indicating whether a latent feature fires for a training record based on an activation threshold corresponding to the latent feature.

20. The system of claim 15, wherein the operations further comprise combining multiple selected latent features into composite features, wherein the composite features are created based in part on synergistic interactions between the selected latent features.
